(19) United States
(12) Patent Application Publication
(10) Pub. No.: US 2008/0134045 A1
(43) Pub. Date: Jun. 5, 2008

(54) SYSTEM AND METHOD FOR ADAPTIVELY AND DYNAMICALLY CONFIGURING A GRAPHICAL USER INTERFACE OF A MOBILE COMMUNICATION DEVICE

(75) Inventors: Sharon FRIDMAN, London (GB); Ben Volach, Sterling, VA (US)

Correspondence Address: PATENT ADMINISTRATOR;KATTEN MUCHIN ROSENMAN LLP, 1025 THOMAS JEFFERSON STREET, N.W., EAST LOBBY: SUITE 700, WASHINGTON, DC, 20007-5201, US

(73) Assignee: NeuStar, Inc., Sterling, VA (US)

(21) Appl. No.: 11/777,901

(22) Filed: Jul. 13, 2007

Related U.S. Application Data
(60) Provisional application No. 60/830,349, filed on Jul. 13, 2006.

(51) Int. Cl. G06F 15/177

(52) U.S. Cl. 715/735

(57) ABSTRACT

A system and method for dynamically configuring a graphical user interface (GUI) of a mobile communication device allow the GUI displayed by the application software running locally on the mobile device to be determined by a remote GUI server without the need for user intervention. The GUI need not be predetermined in the application software installation package, nor downloaded manually by the user. Rather, the set of graphical elements that make up the GUI on the local device can be controlled by the remote GUI server. Upon installation, startup, or during operation of the local client application, the local client can contact the remote GUI server and be provided with the GUI elements that the client requires. Accordingly, the present invention provides remote configuration and manipulation of the GUI elements displayed on a mobile communication device to create new and different user interfaces on that device without user intervention.

The present application claims priority under 35 U.S.C. § 119(e) to U.S. Provisional Application No. 60/830,349, filed on Jul. 13, 2006, the entire contents of which are hereby incorporated by reference herein.

### BACKGROUND

1. Field of the Invention

The present invention relates to telecommunication systems. More particularly, the present invention relates to a system and method for adaptively and dynamically configuring a graphical user interface of a mobile or handheld communication device.

2. Background Information

A mobile or handheld communication device can display a graphical user interface (GUI) through which the user interacts with the device. The GUI is part of the application software that runs locally on the mobile device. However, the GUI is a fixed attribute of the device. The GUI comes as part of the installation package of the application software. The GUI is unpacked and installed during (local) installation of the application software on the mobile or handheld communication device.

Some modifications to the GUI can be made by the user. For example, “skins” are files that are downloaded from websites and installed manually by users onto the mobile or handheld communication device. The skins alter the GUI elements in the applications that support such graphical elements. However, the users are required to actively search for, select, and download these skins manually to their local platform. In addition, once downloaded locally, the user needs to actively choose to install those skins. In other words, these skins are obtained only upon user-demand and intervention. Accordingly, skins can be considered elective, user-controlled graphical elements that can be used to modify the GUI of a mobile device.

To personalize applications running on the mobile device, websites and some applications allow users to change GUI elements to personalize the GUI for themselves. However, it is up to the user to make such personalization decisions. Such personalization uses existing GUI elements available in the application software running locally on the mobile device. There is no delivery of new GUI elements to the client application software, only manipulation of existing GUI elements. As with skins, personalization is obtained only upon user-demand and intervention. Accordingly, application personalization can be considered a user-controlled process that functions within the limits of the graphical elements existing in the application software running locally on the mobile or handheld communication device.

### SUMMARY OF THE INVENTION

A system and method are disclosed for adaptively and dynamically configuring a graphical user interface of a mobile or handheld communication device. In accordance with exemplary embodiments of the present invention, according to a first aspect of the present invention, a system for automatically configuring a graphical user interface of a mobile communication device includes a mobile client application module adapted to execute on the mobile communication device. The mobile client application module includes a graphical user interface (GUI) module. The GUI module is adapted to display a GUI on the mobile communication device. The mobile client application module includes a GUI request module in communication with the GUI module. The GUI request module is adapted to automatically generate a GUI configuration request. The system includes a GUI request processing module in communication with the mobile client application module. The GUI request processing module is adapted to generate a GUI configuration response for configuring the GUI of the mobile communication device.

According to the first aspect, the GUI request module can be adapted to automatically generate the GUI configuration request upon installation of the mobile client application module. Alternatively, the GUI request module can be adapted to automatically generate the GUI configuration request upon startup of the mobile client application module. However, the GUI request module can be adapted to automatically generate the GUI configuration request at any appropriate point or time during operation of the mobile client application module. The GUI configuration request can be adapted to notify the GUI request processing module of existence of the mobile client application module. Additionally or alternatively, the GUI configuration request can be adapted to request instructions from the GUI request processing module for modifying the GUI of the mobile communication device. The GUI configuration request can include additional information, such as device information of the mobile communication device. For example, the device information can comprise information on functionality and/or features supported by the mobile communication device or any other suitable device information.

According to the first aspect, the system can include a GUI provider server. The GUI provider server can comprise the GUI request processing module. The GUI provider server can comprise a server communication module in communication with the GUI request processing module. The server communication module can be adapted to communicate the GUI configuration response to the mobile communication device. The GUI provider server can also comprise a mobile communication information storage module in communication with the GUI request processing module. The mobile communication information storage module can be configured to store attribute information associated with each mobile communication device. According to an exemplary embodiment of the first aspect, the GUI configuration response can comprise a set of GUI elements and GUI configuration information for configuring the GUI of the mobile communication device with the set of GUI elements. For example, the GUI configuration information can comprise instructions for arranging the set of GUI elements within the GUI of the mobile communication device. The GUI module can be adapted to configure the GUI of the mobile communication device in accordance with the GUI configuration response. The mobile client application module can be adapted to establish a communication link with the GUI request processing module when the GUI configuration request is automatically generated.

According to a second aspect of the present invention, a computer-readable medium contain a GUI configuration message structure for adaptively and dynamically configuring a GUI of a mobile communication device. The GUI configuration message structure includes one or more GUI elements. The GUI configuration message structure also includes GUI configuration information for configuring the GUI of the mobile communication device with the one or more GUI elements. The GUI configuration message structure is generated in response to a GUI configuration request message automatically generated by the mobile communication device. The GUI configuration information can comprise instructions for arranging the one or more GUI elements within the GUI of the mobile communication device.

According to a third aspect of the present invention, an apparatus for adaptively and dynamically configuring a graphical user interface includes a mobile communication unit. The mobile communication unit includes GUI. The GUI is adapted to display information to a user. The mobile communication unit also includes a GUI configuration module in communication with the GUI. The GUI configuration module is adapted to automatically generate a GUI configuration request. The GUI configuration module is adapted to receive a GUI configuration response to the GUI configuration request. The GUI configuration response includes one or more GUI elements, and GUI configuration information for configuring the GUI with the one or more GUI elements.

According to the third aspect, the GUI configuration module can be adapted to automatically generate the GUI configuration request upon startup of the mobile communication unit. However, the GUI configuration module can be adapted to automatically generate the GUI configuration request at any suitable time or point during operation of the mobile communication unit. The GUI configuration request can be adapted for notifying of the existence of the mobile communication unit. Additionally or alternatively, the GUI configuration request can be adapted to request instructions for modifying the GUI of the mobile communication unit. The GUI configuration request can comprise device information of the mobile communication unit. The device information can comprise information on the functionality and/or features supported by the mobile communication unit or any other suitable device information.

According to the third aspect, the mobile communication unit can be in communication with a GUI server. The GUI server can comprise a GUI request processing module. The GUI request processing module can be adapted to generate the GUI configuration response for configuring the GUI of the mobile communication unit. The GUI server can include a mobile communication information storage module that is configured to store attribute information associated with each mobile communication unit. The mobile communication unit can be adapted to establish a communication link with the GUI server when the GUI configuration request is automatically generated. The GUI configuration information can comprise instructions for arranging the one or more GUI elements within the GUI of the mobile communication unit. The GUI configuration module can be adapted to configure the GUI of the mobile communication unit in accordance with the GUI configuration response.

According to a fourth aspect of the present invention, an apparatus for adaptively and dynamically configuring a graphical user interface of a mobile communication unit includes a GUI server. The GUI server is in communication with the mobile communication unit. The GUI server comprises a GUI response module. The GUI response module is adapted to receive a GUI configuration request automatically generated by the mobile communication unit. The GUI response module is adapted to generate a GUI configuration response for the mobile communication unit. The GUI configuration response comprises at least one graphical element and GUI configuration information for configuring a GUI of the mobile communication unit with the at least one graphical element.

According to the fourth aspect, the GUI configuration request can be adapted to notify the GUI response module of existence of the mobile communication unit. Additionally or alternatively, the GUI configuration request can be adapted to request instructions from the GUI response module for modifying the GUI of the mobile communication unit. For example, the GUI configuration request can comprise device information of the mobile communication unit, including information on functionality and/or features supported by the mobile communication unit or any other suitable device information. The GUI server can comprise a transceiver module in communication with the GUI response module. The transceiver module can be adapted to communicate the GUI configuration response to the mobile communication unit. The GUI server can include a mobile communication information storage module that is configured to store attribute information associated with each mobile communication unit. The GUI configuration information can comprise instructions for arranging the at least one GUI element within the GUI of the mobile communication unit. The mobile communication unit can be adapted to establish a communication link with the GUI server when the GUI configuration request is automatically generated.

According to a fifth aspect of the present invention, a method of automatically configuring a graphical user interface of a mobile communication device includes the steps of: automatically generating a GUI configuration request by the mobile communication device; automatically generating a GUI configuration response by a GUI provider server in communication with the mobile communication device; and configuring a GUI of the mobile communication device in accordance with the GUI configuration response.

According to the fifth aspect, automatic generation of the GUI configuration request can occur upon installation of a mobile client application on the mobile communication device, upon startup of the mobile communication device, or at any suitable point or time during operation of the mobile communication device. The GUI configuration request can be adapted for notifying of the existence of the mobile communication device. The GUI configuration request can be adapted to request instructions for modifying the GUI of the mobile communication device. The GUI configuration request can comprise device information of the mobile communication device, such as, for example, information on features and/or functionality supported by the mobile communication device or any other suitable device information. The GUI configuration response can comprise a set of GUI elements, and GUI configuration information for configuring the GUI of the mobile communication device with the set of GUI elements. The GUI configuration information can comprise instructions for arranging the set of GUI elements within the GUI of the mobile communication device. The method can include one or more of the following steps: establishing a communication link between the mobile communication device and the GUI provider server when the GUI configuration request is automatically generated; and storing attribute information associated with each mobile communication device.

According to a sixth aspect of the present invention, a method for adaptively and dynamically configuring a graphical user interface includes the steps of: transmitting a graphical user interface (GUI) configuration request automatically generated by a mobile communication unit, wherein the mobile communication unit includes a GUI for displaying information to a user; and receiving a GUI configuration response to the GUI configuration request at the mobile communication unit. The GUI configuration response includes one or more GUI elements, and GUI configuration information for configuring the GUI with the one or more GUI elements.

According to the sixth aspect, the GUI configuration request can be automatically generated upon startup of the mobile communication unit, or at any appropriate time or point during operation of the mobile communication unit. The GUI configuration request can be adapted for notifying of the existence of the mobile communication unit. Additionally or alternatively, the GUI configuration request can be adapted to request instructions for modifying the GUI of the mobile communication unit. For example, the GUI configuration request can comprise device information of the mobile communication unit, such as information on features and/or functionality supported by the mobile communication unit or any other suitable device information. The mobile communication unit can be in communication with a GUI server. The GUI server can generate the GUI configuration response for configuring the GUI of the mobile communication unit. The method can include the step of: establishing a communication link from the mobile communication to the GUI server when the GUI configuration request is automatically generated. The GUI configuration information can comprise instructions for arranging the one or more GUI elements within the GUI of the mobile communication unit. The method can include the step of: configuring the GUI of the mobile communication unit in accordance with the GUI configuration response.

According to a seventh aspect of the present invention, a method for adaptively and dynamically configuring a graphical user interface of a mobile communication unit includes the steps of: receiving a GUI configuration request automatically generated by the mobile communication unit; generating a GUI configuration response for the mobile communication unit, wherein the GUI configuration response includes at least one graphical element and GUI configuration information for configuring a GUI of the mobile communication unit with the at least one graphical element; and communicating the GUI configuration response to the mobile communication unit.

According to the seventh aspect, the GUI configuration request can comprise a notification of the existence of the mobile communication unit. Additionally or alternatively, the GUI configuration request can be adapted to request instructions for modifying the GUI of the mobile communication unit. For example, the GUI configuration request can comprise device information of the mobile communication unit, such as information on the features and/or functionality supported by the mobile communication unit or any other suitable device information. The GUI configuration information can comprise instructions for arranging the at least one GUI element within the GUI of the mobile communication unit. The method can include the step of: configuring the GUI of the mobile communication unit in accordance with the GUI configuration response.

According to an eighth aspect of the present invention, a system for automatically configuring a graphical user interface of a mobile communication device includes a GUI provider server. The GUI provider server is in communication with the mobile communication device. The GUI server includes a GUI response processing module. The GUI response processing module is adapted to receive a GUI configuration request automatically generated by the mobile communication device. The GUI response processing module is adapted to generate a GUI configuration response for the mobile communication device. The GUI configuration response comprises GUI configuration information for configuring graphical elements within a GUI of the mobile communication device. The GUI server also includes a mobile device information storage module in communication with the GUI response processing module. The mobile device information storage module is configured to store attribute information associated with the mobile communication device.

According to a ninth aspect of the present invention, an apparatus for automatically configuring a graphical user interface includes a mobile communication device. The mobile communication device includes means for rendering a GUI. The GUI rendering means is adapted to display information to a user. The mobile communication devices includes means for generating a GUI configuration request in communication with the GUI rendering means. The GUI configuration request generating means is adapted to automatically generate a GUI configuration request. The GUI configuration request generating means is adapted to receive a GUI configuration response to the GUI configuration request. The GUI configuration response includes one or more GUI elements, and GUI configuration information for configuring the GUI with the one or more GUI elements.

According to a tenth aspect of the present invention, an apparatus for automatically configuring a graphical user interface of a mobile communication device includes a GUI server. The GUI server is in communication with the mobile communication device. The GUI server includes means for generating a GUI response. The GUI response generating means is adapted to receive a GUI configuration request automatically generated by the mobile communication device. The GUI response generating means is adapted to generate a GUI configuration response for the mobile communication device. The GUI configuration response comprises at least one graphical element and GUI configuration information for configuring a GUI of the mobile communication device with the at least one graphical element. The GUI server can include means for communicating information in communication with the GUI response generating means. The information communicating means can be adapted to communicate the GUI configuration response to the mobile communication device. The GUI server can also include means for storing mobile device information. The mobile device information storing means can be configured to store attribute information associated with each mobile communication device.

### BRIEF DESCRIPTION OF THE DRAWINGS

Other objects and advantages of the present invention will become apparent to those skilled in the art upon reading the following detailed description of preferred embodiments, in conjunction with the accompanying drawings, wherein like reference numerals have been used to designate like elements, and wherein:

FIG. 1 is a block diagram illustrating a system for automatically configuring a graphical user interface of a mobile communication device, in accordance with an exemplary embodiment of the present invention.

FIG. 2 illustrates a GUI configuration response message structure for adaptively and dynamically configuring the GUI of a mobile communication device, in accordance with an exemplary embodiment of the present invention.

FIG. 3 is a block diagram illustrating an apparatus for adaptively and dynamically configuring a graphical user interface, in accordance with an alternative exemplary embodiment of the present invention.

FIG. 4 is a block diagram illustrating an apparatus for adaptively and dynamically configuring a graphical user interface of a mobile communication unit, in accordance with an alternative exemplary embodiment of the present invention.

FIG. 5 is a flowchart illustrating steps for automatically configuring a graphical user interface of a mobile communication device, in accordance with an exemplary embodiment of the present invention.

FIG. 6 is a flowchart illustrating steps for adaptively and dynamically configuring a graphical user interface, in accordance with an exemplary embodiment of the present invention.

FIG. 7 is a flowchart illustrating steps for adaptively and dynamically configuring a graphical user interface of a mobile communication unit, in accordance with an exemplary embodiment of the present invention.

### DETAILED DESCRIPTION OF THE PREFERRED EMBODIMENTS

Exemplary embodiments of the present invention are directed to a system and method for adaptively and dynamically configuring a graphical user interface of a mobile or handheld communication device. According to exemplary embodiments, the present invention can allow the graphical user interface displayed by the application software running locally on the mobile or handheld communication device to be determined by a remote graphical user interface server without the need for user intervention on the device side. The graphical user interface need not be predetermined in the application software installation package, nor downloaded manually by the user. Rather, the set of graphical elements that make up the graphical user interface on the local device can be controlled by the remote graphical user interface server. Upon installation, startup, or during operation of the local client application, the local client can contact the remote graphical user interface server and be provided with any or all of the graphical user interface elements that the client requires. The local client can then auto-adapt its graphical user interface without the need of user intervention. Accordingly, exemplary embodiments of the present invention can allow remote configuration and manipulation of the graphical user interface elements displayed on a mobile or handheld communication device to create new and different user interfaces on that device without user intervention.

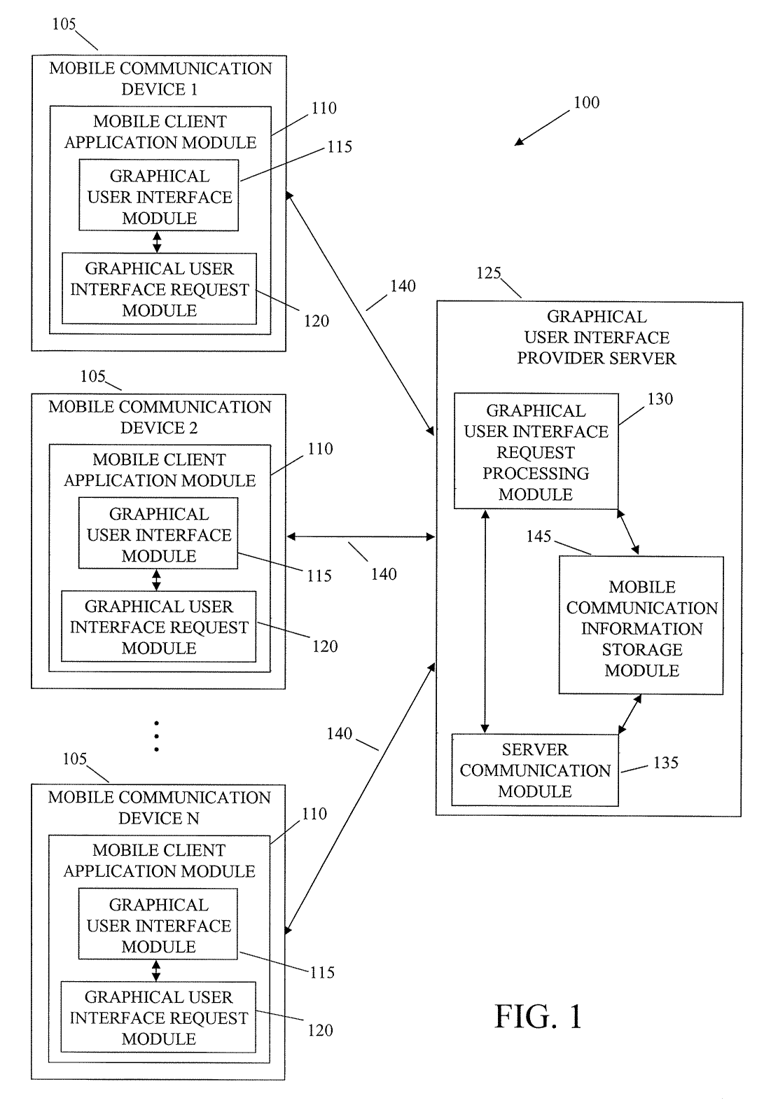

These and other aspects and embodiments of the present invention will now be described in greater detail. FIG. 1 is a block diagram illustrating a system 100 for automatically configuring a graphical user interface of a mobile or handheld communication device, in accordance with an exemplary embodiment of the present invention. The system 100 can support any suitable number of handheld or mobile communication devices 105 (e.g., mobile communication device 1, mobile communication device 2, mobile communication device 3, . . . , mobile communication device N, where N is any appropriate number). Each mobile communication device 105 can be comprised of any suitable type of mobile, portable, handheld, or otherwise wireless module, device, or unit that is capable of communicating messages or other information using any appropriate type of mobile or wireless messaging service or communication mechanism. For example, such mobile communication devices 105 can communicate via a suitable mobile network that can be operated or otherwise managed by any appropriate type of mobile network operator, mobile virtual network operator, wireless service provider, wireless carrier, mobile phone operator, or cellular company or organization. However, those of ordinary skill in the art will recognize that exemplary embodiments of the present invention can be used with any suitable type of wired and/or wireless communication device (e.g., a computer or PC that is adapted to communicate via a network, such as an intranet or internet, using a suitable network connection).

Each mobile communication device 105 includes a mobile client application module 110 that is adapted to execute on the mobile communication device 105. According to an exemplary embodiment, the mobile client application module 110 can comprise the operating system software for running and operating the mobile communication device 105. Other applications or modules can be configured to run within such an operating system environment to provide other various and suitable features and functionality for the mobile communication device 105. According to an alternative exemplary embodiment, the mobile client application module 110 can comprise an application or other software that runs within an operating system that is provided by and with the mobile communication device 105. In such an alternative exemplary embodiment, the mobile client application module 110 can comprise one or a collection of application modules that provide the functionality described herein, in addition to other application modules that may be running or otherwise executing within the operating system environment provided by or with the mobile communication device 105. The actual implementation of the mobile client application module 110 will depend on the type of mobile communication device 105 and the functionality and features of such a device, and other like factors.

Each mobile client application module 110 includes a graphical user interface (GUI) module 115. The GUI module 115 is adapted or otherwise configured to display a GUI on the mobile communication device 105. The GUI is a type of user interface that allows users to interact with the mobile communication device 105 (e.g., through a suitable display screen or monitor on the mobile communication device 105). The GUI can employ graphical icons, visual indicators, or other such graphical elements, along with text labels and/or text navigation to represent and display graphical and/or textual information and actions available to a user. Such actions can be performed through direct manipulation of the graphical elements displayed within the GUI (e.g., through selection of corresponding keys on the mobile communication device 105, through a suitable pointer device, such as a stylus or human finger for touch-sensitive screens, through voice commands, or the like). Accordingly, a “GUI” can comprise any suitable arrangement or configuration of graphical and/or textual elements on the display screen of the mobile communication device 105 for conveying a desired “look and feel” to the mobile communication device 105 display. Each of the “graphical elements” arranged within such a GUI can comprise any suitable type of graphical and/or textual information for display to a user of the mobile communication device 105. For example, a picture displayed within the GUI can be comprised of a single graphical element that represents the entire picture. Alternatively, the picture can be comprised of a collection of graphical elements, each of which represents a piece or portion of the overall picture, and the collection can be suitably arranged within the GUI to form the picture.

The mobile client application module 110 includes a GUI request module 120 in communication with the GUI module 115. The GUI request module 120 is adapted to automatically generate a GUI configuration request. To support such a request, the system 100 includes a GUI provider server 125 that is in communication or otherwise capable of communicating with each of the mobile communication devices 105. The GUI provider server 125 includes a GUI request processing module 130. The GUI request processing module 130 is adapted to generate a GUI configuration response to the GUI configuration request for configuring the GUI of the mobile communication device 130. The GUI provider server 125 can also include a server communication module 135 in communication with the GUI request processing module 130. The server communication module 135 is adapted to communicate the GUI configuration response to the given mobile communication device 105. For example, the network or communication link 140 between the GUI provider server 125 and each mobile communication device 105 can comprise any suitable type of wireless or wired communication link, connection, or medium that uses an appropriate form of wireless or wired communication mechanism, protocol, or technique. The communication link 140 can be persistent or intermittent. For example, according to an exemplary embodiment, the mobile client application module 110 can be configured to establish the communication link 140 with the GUI provider server 125 (and GUI request processing module 130) when the GUI configuration requested is automatically generated (or at any suitable time), so that a persistent communication link 140 with the GUI provider server 125 does not need to be maintained. However, such a communication link 140 can be established at any appropriate time and for any suitable duration. Thus, the mobile communication device 105 and the GUI provider server 125 comprise a suitable client-server/request-response architecture that can be used to create or update the GUI displayed on the mobile communication device 105.

According to an exemplary embodiment, the GUI configuration request can be adapted to request instructions from the GUI request processing module 130 for configuring or re-configuring the GUI of the mobile communication device 105. For example, the GUI configuration request can comprise a request for instructions to modify any portion of or the entire GUI. Alternatively, the GUI configuration request can simply comprise a notification to the GUI request processing module 130 of the existence of the mobile client application module 110 and/or the mobile communication device 105. For example, each time the GUI provider server 125 receives such a notification from a given mobile communication device 105, the GUI request processing module 130 can supply predetermined instructions for configuring or re-configuring a particular portion or the entire GUI. The GUI configuration request can include any suitable additional information that can be used for requesting instructions to configure or re-configure the GUI, such as for example, the current arrangement or layout of the GUI, the composition of the GUI (e.g., a listing and/or description of the graphical elements that make up the GUI), and other like information. For example, the GUI configuration request can comprise device information of the mobile communication device 105, such as information on the features and/or functionality supported by the mobile communication device 105, installed applications and other software elements running or otherwise residing on the mobile communication device 105, the device's hardware configuration, the location configuration of the mobile communication device 105 (e.g., a phone “profile,” such as, for example, silent mode), and/or any other suitable device information.

According to exemplary embodiments, the GUI configuration request is generated by the GUI request module 120 automatically and without the need of user intervention. The GUI configuration request can be automatically generated at any appropriate time by the GUI request module 120. For example, the GUI request module 120 can be adapted to automatically generate the GUI configuration request upon installation of the mobile client application module 110 on the mobile communication device 105 (e.g., when the software package is installed on the device). Alternatively, the GUI request module 120 can be adapted to automatically generate the GUI configuration request upon startup of the mobile client application module 110. For example, each time the user turns or switches on the mobile communication device 105, causing activation of the mobile client application module 110, the GUI request module 120 can automatically generate a GUI configuration request. However, the GUI request module 120 can be adapted to automatically generate the GUI configuration request at any appropriate time during operation of the mobile client application module 110 and/or mobile communication device 105.

Thus, according to exemplary embodiments, the mobile client application module 110 can contact the GUI provider server 125 over the communication link 140 to request instructions for modifying the GUI of the mobile communication device 105 or to notify the GUI provider server 125 of its existence. In either instance, such a GUI configuration request can include suitable additional information such as, for example, capabilities or limitations of the mobile communication device 105 and/or the mobile client application module 110, as well as other suitable information as discussed in more detail below. Upon receipt of the GUI configuration request, the GUI provider server 125 is adapted to examine the incoming request or notification. Based on GUI server policies, the GUI provider server 125 can generate, formulate or otherwise construct a suitable GUI configuration response to reply to the request/notification.

According to an exemplary embodiment, the GUI provider server 125 can include a mobile communication information storage module 145 in communication with the GUI request processing module 130. The mobile communication information storage module 145 can be comprised of any suitable type of computer-readable or other computer storage medium capable of storing information in electrical or electronic form. The mobile communication information storage module 145 can be configured to store attribute or other suitable information associated with each mobile communication device 105. In other words, the mobile communication information storage module 145 can be configured to maintain or otherwise store capabilities, specifications, attributes, preferences, and other like information for each mobile communication device 105. Such “device attributes” can include, but are not limited to, device identification information (e.g., vendor/model, UserAgent header, or the like), screen size of the device, whether the device supports color or not, the User Agent Profile (UAProf) (e.g., for capturing the capability and preference information for wireless devices), Composite Capabilities/Preference Profiles (CC/PP) (e.g., a description of a device's capabilities and user preferences), device/client type, request/notification type, user type, or other like specifications or preferences associated with each device and user.

For example, the device identification can be obtained from the GUI configuration request by the GUI request processing module 130, if such information is provided by the mobile communication device 105 as part of the request. Alternatively, the GUI request processing module 130 can be configured to communicate (via the server communication module 135) a suitable device identification detection message or query to request the identity from the mobile communication device 105. Such a query can be formed as part of an established protocol message or as part of a unique message structure supported by the system 100. Such an identity request message or query can be sent at any suitable time by the GUI provider server 125, such as, for example, upon receipt of a GUI configuration request message, when a mobile communication device 105 starts up and makes an initial connection to the GUI provider server 125 (e.g., before any GUI configuration request message is sent), or at any other suitable time or interval. Once the identity of the device has been obtained, the device identification can be used to locate or otherwise retrieve additional device attributes for a particular mobile communication device 105 or group or collection of such devices from the mobile communication information storage module 145. The retrieved device attributes can be used by the GUI request processing module 130 in addition or alternatively to the information contained in the GUI configuration request to define an optimal GUI configuration for the given mobile communication device 105.

For purposes of illustration and not limitation, Table 1 illustrates examples of device attributes that can be maintained in the mobile communication information storage module 145 for two mobile communication devices 105:

TABLE 1
Device Attributes for Two Mobile Communication Devices

| | | | | GRAPHICAL |
|---|---|---|---|---|
| DEVICE | VENDOR/ | SCREEN | COLOR | ELEMENTS |
| ID | MODEL | SIZE | SUPPORT? | TO SEND |
| 001 | CellMAXX | 96 × 80 pixels | YES | Color GUI |
| | 3500 | | | Elements C1, |
| | | | | C1, C3, C4 |
| 002 | DPHONE | 48 × 40 pixels | NO | Monochrome |
| | DP400 | | | GUI Elements |
| | | | | M1, M2, M3 |

In one example, the first mobile communication device 105 (i.e., mobile device 001) automatically sends a GUI configuration request to the GUI provider server 125. The GUI configuration request contains the device ID (i.e., 001) and a request for an entirely new color GUI (e.g., to display the logo of the mobile network operator to which the device subscribes). Using the device ID, the GUI request processing module 130 can retrieve the corresponding device attributes from the look-up Table 1, e.g., the mobile device 001 is a CellMAXX model 3500 phone with a screen size of 96×80 pixels that supports color. In addition, such a look-up table can include the corresponding color graphical elements (e.g., color GUI elements C1, C2, C3, and C4) and appropriate configuration information for populating the GUI configuration response for the CellMAXX 3500 phone.

In a second example, the second mobile communication device 105 (i.e., mobile device 002) also automatically sends a GUI configuration request to the GUI provider server 125. The GUI configuration request contains the device ID (i.e., 002) and also a request for an entirely new color GUI. Using the device ID, the GUI request processing module 130 can again retrieve the corresponding device attributes from the look-up Table 1, e.g., the mobile device 002 is a DPHONE model DP400 phone with a screen size of 48×40 pixels. Even though the mobile device 002 requested a new color GUI, the device attributes maintained for this device indicate that the device does not support color. Thus, the GUI request processing module 130 can override or otherwise modify the GUI configuration requested by the DPHONE DP400 to supply only monochrome graphical elements. Accordingly, the GUI request processing module 130 can retrieve the monochrome graphical elements (e.g., monochrome GUI elements M1, M2, and M3) and appropriate configuration information for populating the GUI configuration response for the DPHONE DP400 phone. Thus, the GUI provider server 125 can provide a GUI and a GUI configuration response that is different than the one requested by the mobile communication device 105 based on device attributes associated with the requesting device.

Additionally or alternatively, the mobile communication information storage module 145 (or suitable separate storage) can be used to store user profile and user preferences for automatically specifying the configuration of the GUI of the mobile communication device 105. For example, on setup of the service by the user (or at any other suitable time), the user can specify certain preferences or parameters that can be retrieved and used by the GUI request processing module 130 for generating the GUI configuration response to a GUI configuration request. In other words, although the GUI configuration request is still automatically generated by the GUI request module 120 without the need for user intervention, the GUI request processing module 130 can use previously-established user preferences to appropriately generate the GUI configuration response.

Additionally or alternatively, the GUI request processing module 130 (or suitable storage within or in connection with the GUI provider server 125) can maintain rules specified by the service provider or operator of the system 100. In other words, the operator of the system 100 can specify operator preferences or other rules that are used by the GUI request processing module 130 to generate the GUI configuration response for a particular user, group of users, mobile communication device 105, or group of mobile communication devices 105. For example, the operator or service provider can specify a rule that all users with visual disabilities will get a GUI with large visuals/fonts. One of the device/user attributes maintained by the mobile communication information storage module 145 can specify whether the user of a particular mobile device has such a visual handicap. If so, then the GUI configuration request from that mobile communication device 105 can be appropriately processed to provide a GUI configuration response with graphical elements with large visuals/fonts. Such a response may override or modify the request from the (disabled) user, and such a response would, of course, be different from one sent to a similar device whose user is not visually disabled.

According to an additional exemplary embodiment of the present invention, the GUI provider server 125 can be in communication with other remote servers or sources, and configured to obtain GUI configuration information maintained by those remote servers or sources for use in generating the GUI configuration response. In other words, the GUI configuration response can be generated by the GUI request processing module 130 in accordance with GUI configurations that have been performed on other servers or systems. For example, a user can change their “My eBay” GUI configuration on the eBay website via a suitable Web browser running on the user's PC. Such remote GUI configuration information can be obtained by the GUI provider server 125 in any suitable manner (e.g., by polling the eBay servers, registering for notification of a suitable GUI event from the eBay servers, appropriate exception processing, or other like mechanism). Consequently, the GUI request processing module 130 can generate a GUI configuration response that provides a graphical configuration to match the device attributes of the mobile device and that incorporates any changes that the user may have made to their corresponding PC-based eBay configuration. Thus, when the user accesses their “My eBay” via the mobile communication device 105, the “look and feel” of their “My eBay” graphical environment on the mobile device is similar or substantially similar to that experienced on the user's PC.

Thus, the GUI configuration response can be generated by the GUI request processing module 130 in accordance with numerous factors and inputs, including, but not limited to, information contained in the GUI configuration request, matching user preferences and profiles (e.g., those maintained by the mobile communication information storage module 145), matching operator policies or preferences (e.g., those maintained in or in conjunction with the GUI request processing module 130), GUI configuration information from other graphical sources or servers, optimization of the user experience for the given user by achieving an optimal user experience for the given device of that user (e.g., in accordance with device attributes maintained in the mobile communication information storage module 145), and other like factors.

Accordingly, to generate the GUI configuration response according to one exemplary embodiment, the GUI request processing module 130 can include appropriate look-up tables that can map GUI configuration requests to various predetermined GUI configuration responses. Such look-up tables can be stored in a suitable computer memory or other computer storage device internal to or in communication with the GUI request processing module 130 or the GUI provider server 125. For example, if the GUI configuration request comes from a particular, individual mobile communication device 105 or mobile client application module 110, then the look-up table can indicate the GUI elements and GUI configuration information corresponding that particular, individual device/client. However, if the GUI configuration request comes from a certain type or model of mobile communication device 105 or a particular version of the mobile client application module 110, then the look-up table can indicate the GUI elements and GUI configuration information corresponding to that model or version. As skilled artisans will recognize, the nature and content of the information contained in such a look-up table and the mapping of the mobile communication device 105/mobile client application module 110 to GUI elements and GUI configuration information will depend on, for example, the nature and type of the mobile communication devices 105 and mobile client application modules 110 (including supported features and functionality and device attributes) and other like factors. In such a manner, GUI configuration responses can be generated or otherwise tailored to individual devices/clients/users or a range or group of devices/clients/users.

Alternatively, suitable Boolean or other logic or rules can be used to determine the GUI elements and GUI configuration information for responding to requests from the devices/clients. For example, continuing with the present illustration, Boolean logic can be used to determine that IF the GUI configuration request comes from a particular, individual mobile communication device 105 or mobile client application module 110, THEN generate a GUI configuration response with the GUI elements and GUI configuration information corresponding that particular, individual device/client. Likewise, Boolean logic can be used to determine that IF the GUI configuration request comes from a certain type or model of mobile communication device 105 or a certain version of the mobile client application module 110, THEN generate a GUI configuration response with the GUI elements and GUI configuration information corresponding to the given model or version. The complexity of such logic or rules will depend on the nature and type of mobile communication devices 105 and mobile client application modules 110, as well as other like factors. More complex mechanisms, such as neural networks, can be adapted to “learn” how to respond to such GUI configuration requests. For example, according to an exemplary embodiment, the GUI request processing module 130 can “learn” that a model or type of mobile communication device 105 or version of mobile client application module 110 requires certain GUI elements arranged in a certain configuration. Such information can be fed back to the GUI request processing module 130 to allow such “learning” to take place and to refine these or other GUI configuration response algorithms.

Based on appropriate GUI server policies, rules, logic, algorithms, or the like, the GUI provider server 125 can reply to the request/notification with an appropriate GUI configuration response that can include one or more GUI elements and their proper configuration or arrangement. According to exemplary embodiments, the configuration or arrangement information can comprise instructions regarding the layout and order of the GUI elements in the GUI of the mobile communication device 105. The instructions can comprise, for example, an Extensible Markup Language (XML) or other Standardized Generalized Markup Language (SGML) file, Hypertext Markup Language (HTML) commands, or other suitable file formatting instructions, commands, definitions, or schema for representing and specifying a GUI layout, contents, and structure. The set of GUI elements and accompanying instructions are delivered to the given mobile communication device 105 and accompanying mobile client application module 110 over the communication link 140. The mobile client application module 110 can use the received GUI elements and instructions to present a new or modified GUI to the user. For example, the GUI module 115 can be adapted to configure the GUI of the mobile communication device 105 in accordance with the GUI configuration response. However, the GUI configuration response can include any suitable type of information that is capable of specifying the layout, content, and structure of the GUI of the mobile communication device 105, and need not include specific graphical elements (e.g., the existing graphical layout of the mobile communication device 105 may simply require rearranging and not any new or additional GUI elements).

In particular, the GUI configuration response can use the GUI elements already existing in the GUT of the mobile communication device 105 by specifying instructions to rearrange the layout of those (existing) GUT elements, without the need for sending additional or alternative GUT elements. For example, the GUT configuration request can specify or otherwise list the GUT elements that currently reside in or are otherwise being used by the GUI of the mobile communication device 105 (e.g., the device has GUT elements 101, 103, 104, and 106, or other like designations, referred to as the “GUT element IDs”). Accordingly, the GUT configuration response can provide instructions for rearranging or otherwise modifying the layout of those existing GUT elements. Additionally or alternatively, if GUT element IDs or other specification of the GUT elements residing on the device are included in the GUT configuration request, the GUT request processing module 130 can use such information to provide only those additional GUT elements needed by the mobile communication device 105. In other words, the GUT request processing module 130 need not send GUI elements already existing on the device. For purposes of illustration and not limitation, a particular mobile device requires a total of 6 GUT elements (e.g., GUI Elements 101, 102, 103, 104, 105, and 106) to update its GUT, per suitable rules maintained for that device. The mobile device sends a GUT configuration request that specifies that the device already has GUT elements 101, 103, 104, and 106. Alternatively, if such information is not included in the request, the GUT request processing module 130 can determine that the mobile device maintains four of the six GUT elements by referring to a suitable rule established for that mobile device. Using such information and the rules established for that mobile communication device 105, the GUT request processing module 130 can generate a GUT configuration response that includes the missing GUI elements, i.e., GUI elements 102 and 105. By sending the missing GUI elements needed by the mobile device, rather than all GUI elements, the size of the GUI configuration response message can be reduced.

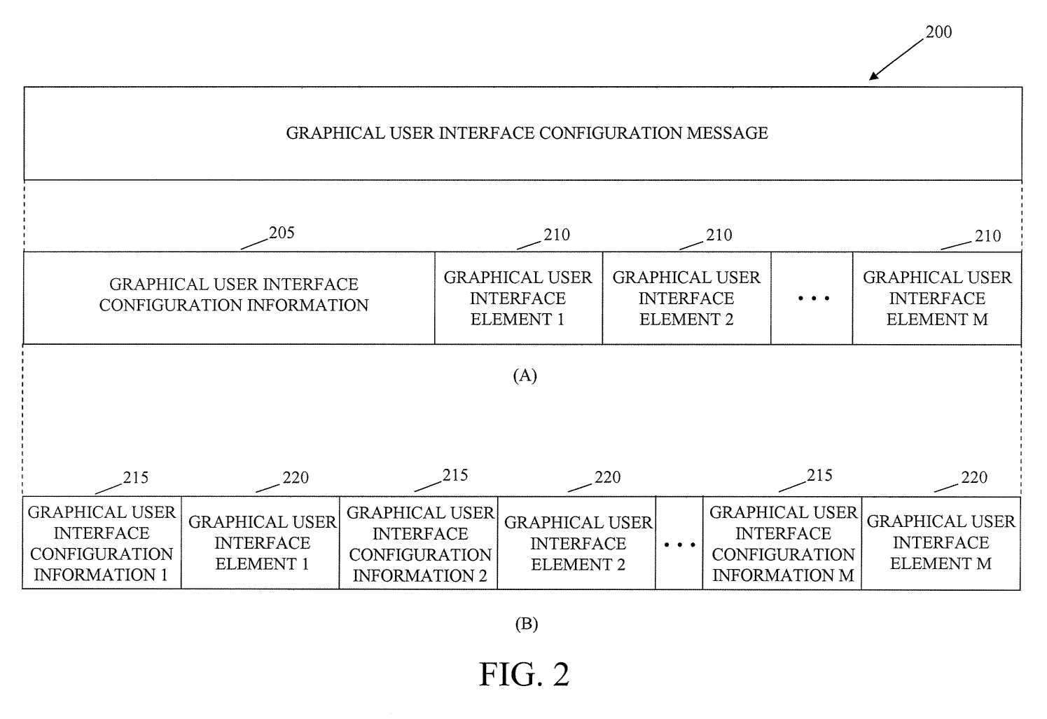

According to exemplary embodiments, the GUI configuration response can comprise one or more GUI elements (e.g., a set of graphical elements) and/or GUI configuration information. As discussed above, the GUI configuration information comprises instructions for arranging the GUI elements within the GUI of the mobile communication device 105. The GUI elements and GUI configuration information can be sent together in a single message, or separately as parts of different messages. For purposes of illustration and not limitation, FIG. 2 illustrates a GUI configuration response message structure 200 for adaptively and dynamically configuring the GUI of a mobile communication device 105, in accordance with an exemplary embodiment of the present invention. The GUI configuration response message structure 200 incorporate both GUI elements and GUI configuration information in a single message, although separate messages can also be used. In FIG. 2A, the GUI configuration response message structure 200 includes a first portion that includes all or substantially all of the GUI configuration information 205 for configuring the GUI of the mobile communication device 105. The remainder of the GUI configuration response message structure 200 includes the one or more GUI elements 210 (e.g., GUI element 1, GUI element 2, . . . , GUI element M, where M is any suitable number) that are to be arranged according to the GUI configuration information 205.

According to an alternative exemplary embodiment, FIG. 2B illustrates a GUI configuration response message structure 200 in which the GUI configuration information 215 and GUI elements 220 are interspersed throughout the message structure. In such an alternative message structure, each portion of GUI configuration information 215 is “paired” or otherwise associated with the particular GUI element 220 corresponding to the given instructions. As illustrated in FIG. 2B, such an alternative message structure can include any suitable number of GUI configuration information 215 portions (e.g., GUI configuration information 1, GUI configuration information 2, . . . , GUI configuration information M, where M is any suitable number) and corresponding GUI elements 220 (e.g., GUI element 1, GUI element 2, . . . , GUI element M) in suitable configuration/element pairs (or as appropriately distributed throughout the configuration response message structure 200 illustrated in FIG. 2B). In either exemplary embodiment, the GUI configuration response message structure 200 can include additional portions or sections, such as a suitable header, checksum, or the like, as needed to support the functionality of the system 100. According to an alternative exemplary embodiment, the GUI configuration response message structure 200 can include GUI configuration information without corresponding GUI elements (e.g., when the existing graphical layout of the mobile communication device 105 simply requires rearranging and not any new or additional GUI elements).

For purposes of illustration and not limitation, several examples of uses of the system 100 and exemplary embodiments of the present invention will be described. In the first example, an mobile client application module 110, running in a Java 2 Micro Edition (J2ME) environment, is launched on the mobile communication device 105. Upon launch, the mobile client application module 110 contacts the GUI provider server 125 to request a set of GUI elements (via a suitable GUI configuration request generated by the GUI request module 120). The GUI provider server 125, which can be operated by a mobile operator, communicates the set of GUI elements to the handset application. Accompanying the set of GUI elements is GUI configuration information that contains the layout of the GUI graphical elements. The graphics of the GUI can be designed according to the mobile operator's branding guidelines, and an extra graphic screen (with various forms) unique to the type of mobile communication device 105 on which the mobile client application module 110 resides. The GUI displayed by the mobile client application module 110 is, therefore, fully determined and delivered by the remote GUI provider server 125. As will be recognized by those of ordinary skill in the art, the GUI elements and/or GUI configuration information supplied to the mobile client application module 110 are configured to match or otherwise be compatible with the particular operational environment (e.g., mobile operating system and/or graphical environment) running on the given mobile communication device 105. In the present example, the supplied GUI elements and GUI configuration information would match or otherwise be fully compatible with the JSME environment.

In the second example, a mobile handset manufacturer ships a mobile client application module 110, such as a game application, on mobile communication devices 105 produced by that manufacturer. The mobile client application module 110 has no predetermined GUI. When a mobile operator puts the mobile communication device 105 to use on their network, the mobile client application module 110 can receive GUI instructions from the operator's GUI provider server 125. The mobile client application module 110 (a game in the present example) can receive a differently branded, customized GUI in every different operator environment in which it is put to use. Accordingly, exemplary embodiments of the present invention can provide a platform-, protocol-, and environment-independent mechanism and means for modifying, delivering, and controlling the GUI of mobile communication devices 105 from a remote server.

Those of ordinary skill in the art will recognize that each of the modules of the system 100 can be located locally to or remotely from each other, while use of the system 100 as a whole still occurs within a given country, such as the United States. For example, merely for purposes of illustration and not limitation, the GUI provider server 125 (including the GUI request processing module 130, server communication module 135, and mobile communication information storage module 145) can be located extraterritorially to the United States (e.g., in Canada and/or in one or more other foreign countries). However, each or any of the mobile communication devices 105 (including the mobile client application module 110, GUI module 115, and GUI request module 120) can be located within the United States, such that the control of the system 100 as a whole is exercised and beneficial use of the system 100 is obtained by the user within the United States.

Each of modules of the system 100, including the mobile communication device 105, mobile client application module 110, GUI module 115, GUI request module 120, GUI provider server 125, GUI request processing module 130, server communication module 135, and mobile communication information storage module 145, or any combination thereof, can be comprised of any suitable type of electrical or electronic component or device that is capable of performing the functions associated with the respective element. According to such an exemplary embodiment, each component or device can be in communication with another component or device using any appropriate type of electrical connection or communication link (e.g., wireless, wired, or a combination of both) that is capable of carrying such information. Alternatively, each of the modules of the system 100 can be comprised of any combination of hardware, firmware and software that is capable of performing the functions associated with the respective module.

Alternatively, each or both of the mobile communication devices 105 and GUI provider server 125 of the system 100 can be comprised of one or more microprocessors and associated memory(ies) that store the steps of a computer program to perform the functions of one or more of the modules of the system 100. The microprocessor can be any suitable type of processor, such as, for example, any type of general purpose microprocessor or microcontroller, a digital signal processing (DSP) processor, an application-specific integrated circuit (ASIC), a programmable read-only memory (PROM), an erasable programmable read-only memory (EPROM), an electrically-erasable programmable read-only memory (EEPROM), a computer-readable medium, or the like. The memory can be any suitable type of computer memory or any other type of electronic storage medium, such as, for example, read-only memory (ROM), random access memory (RAM), cache memory, compact disc read-only memory (CDROM), electro-optical memory, magneto-optical memory, or the like. As will be appreciated based on the foregoing description, the memory can be programmed using conventional techniques known to those having ordinary skill in the art of computer programming to perform the functions of one or more of the modules of the system 100. For example, the actual source code or object code of the computer program can be stored in the memory.

The system 100 can include suitable additional modules as necessary to assist or augment the functionality of any or all of the modules of the system 100. For example, the system 100 can include one or more database or storage modules that can be in communication with, for example, one or more of modules of the GUI provider server 125. Such additional storage modules can be configured to store any suitable type of information generated or used by or with the system 100, including, for example, information on the mobile communication devices 105, GUI configuration information, GUI elements, GUI provider server policies/rules, and other like information. Such storage modules can be comprised of any suitable type of computer-readable or other computer storage medium capable of storing information in electrical or electronic form.

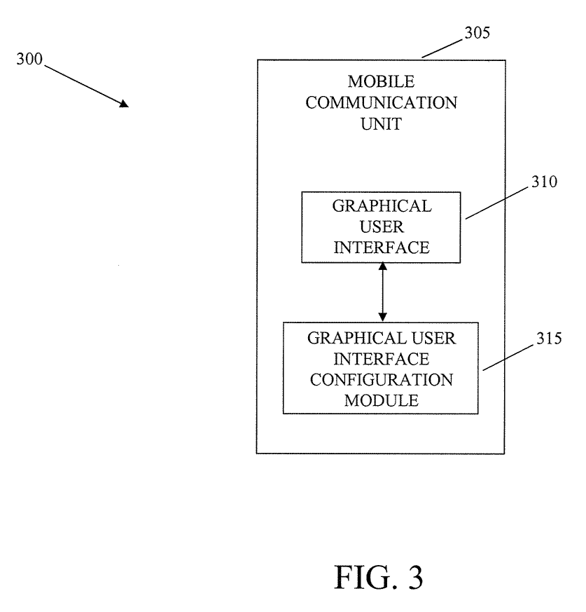

Alternative architectures or structures can be used to implement the various functions of the system 100 as described herein. For example, functions from two or more modules can be implemented in a single module, or functions from one module can be distributed among several different modules. For purposes of illustration and not limitation, FIG. 3 is a block diagram illustrating an apparatus 300 for adaptively and dynamically configuring a GUI, in accordance with an alternative exemplary embodiment of the present invention.

The apparatus 300 includes a mobile communication unit 305. The mobile communication unit 305 includes a GUI 310. The GUI 310 is adapted to display information to the user of the mobile communication unit 305 (e.g., in a manner similar to that described previously for the GUI module 115). The mobile communication unit 305 includes a GUI configuration module 315. The GUI configuration module 315 is adapted to automatically generate a GUI configuration request (e.g., in a manner similar to that described previously for the GUI request module 120). The GUI configuration module can be further configured to receive a GUI configuration response to the GUI configuration request. As discussed previously, the GUI configuration response can comprise one or more GUI elements and GUI configuration information for configuring the GUI with the one or more GUI elements.

According to the present alternative exemplary embodiment, the GUI configuration module 315 can be adapted to automatically generate the GUI configuration request upon startup of the mobile communication unit 305. However, the GUI configuration module 315 can be adapted to automatically generate the GUI configuration request at any appropriate time during operation of the mobile communication unit 305. The GUI configuration request can be adapted for notifying of the existence of the mobile communication unit 305. Additionally or alternatively, the GUI configuration request can be adapted to request instructions for modifying the GUI 310 of the mobile communication unit 305. For example, the GUI configuration request can comprise device information of the mobile communication unit 305 (e.g., features and functionality supported by the mobile communication unit 305 or other like device information as discussed previously).

The mobile communication unit 305 can be in communication with a GUI server, such as, for example, the GUI provider server 125. Accordingly, the mobile communication unit 305 can be adapted to establish a communication link (e.g., persistent or intermittent) with the GUI server when the GUI configuration request is automatically generated. As discussed previously, the GUI configuration information included in the GUI configuration response can comprise instructions for arranging the one or more GUI elements within the GUI 310 of the mobile communication unit 305. The GUI configuration module 315 can be adapted to configure the GUI 310 of the mobile communication unit 305 in accordance with the information contained in the GUI configuration response.

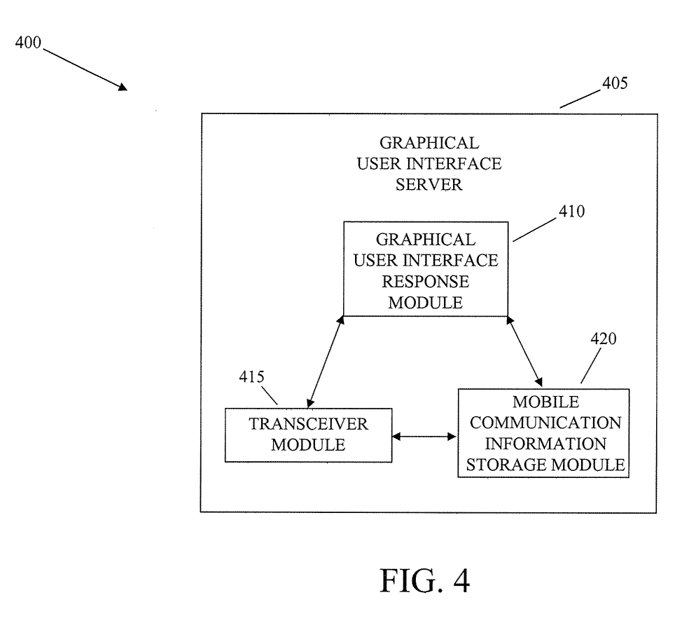

FIG. 4 is a block diagram illustrating an apparatus 400 for adaptively and dynamically configuring a GUI of a mobile communication unit, in accordance with an alternative exemplary embodiment of the present invention. The apparatus 400 includes a GUI server 405. The GUI server 405 is in communication with the mobile communication unit (e.g., the mobile communication device 105 or the mobile communication unit 305). The GUI server 400 includes a GUI response module 410. The GUI response module 410 is adapted to receive a GUI configuration request automatically generated by the mobile communication unit. The GUI response module 410 is also adapted to generate a GUI configuration response for the mobile communication unit. As discussed previously, the GUI configuration response includes at least one graphical element and GUI configuration information for configuring the GUI of the mobile communication unit with the at least one graphical element. The GUI server 400 can also include a transceiver module 415 in communication with the GUI response module 410. The transceiver module 415 is adapted to communicate the GUI configuration response to the mobile communication unit. The GUI server 400 includes a mobile communication information storage module 420. The mobile communication information storage module 420 is adapted to store attribute information associated with each mobile communication unit. Other alternative architectures or structures can be used to implement the various functions of the system 100 and apparatuses 300 and 400 as described herein.

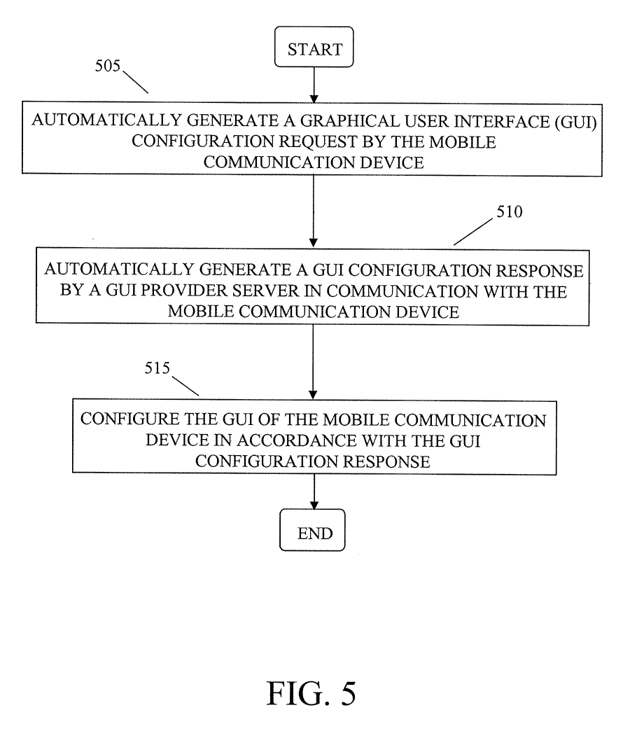

FIG. 5 is a flowchart illustrating steps for automatically configuring a graphical user interface of a mobile communication device, in accordance with an exemplary embodiment of the present invention. In step 505, a GUI configuration request is automatically generated by the mobile communication device. For example, step 505 can occur upon installation of a suitable mobile client application on the mobile communication device. Alternatively, step 505 can occur upon startup of the mobile communication device. However, step 505 can occur at any suitable time or point during operation of the mobile communication device. The GUI configuration request can be adapted to request instructions for modifying the GUI of the mobile communication device. Additionally or alternatively, the GUI configuration request is adapted for notifying of the existence of the mobile communication device. The GUI configuration request can include suitable additional information, such as device information of the mobile communication device. For example, the device information can comprise information on the features and/or functionality supported by the mobile communication device or other like device information, as discussed previously.

In step 510, a GUI configuration response is automatically generated by a GUI provider server in communication with the mobile communication device. According to an exemplary embodiment, the GUI configuration response can comprise, for example, a set of GUI elements and associated GUI configuration information for configuring the GUI of the mobile communication device with the set of GUI elements. For example, the GUI configuration information can comprise instructions for arranging the set of GUI elements within the GUI of the mobile communication device. The method can also include the step of storing attribute information associated with each mobile communication device. Such attribute information can be used in step 510 to generate the GUI configuration response, as described previously. According to an exemplary embodiment, a communication link can be established between the mobile communication device and the GUI provider server when the GUI configuration request is automatically generated. In step 515, the GUI of the mobile communication device can be configured in accordance with the GUI configuration response.

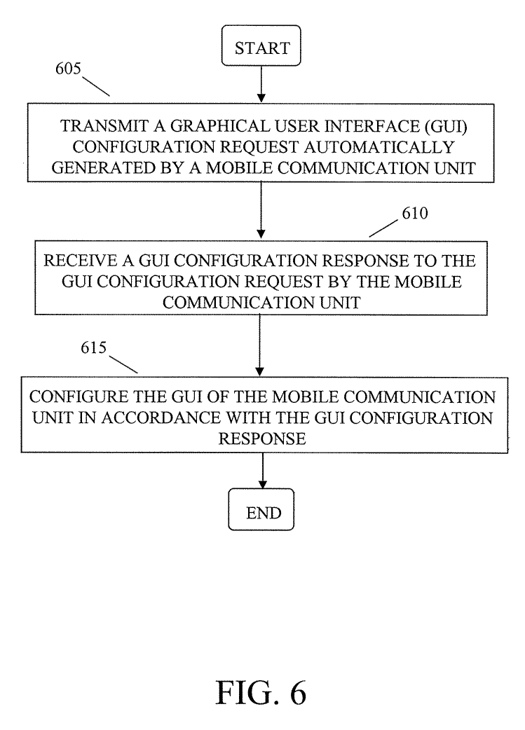

FIG. 6 is a flowchart illustrating steps for adaptively and dynamically configuring a graphical user interface, in accordance with an exemplary embodiment of the present invention. In step 605, a GUI configuration request automatically generated by a mobile communication unit is transmitted. The mobile communication unit includes a GUI for displaying information to the user. The GUI configuration request can be automatically generated upon startup of the mobile communication unit. However, the GUI configuration request can be automatically generated at any appropriate time or point during operation of the mobile communication unit. The GUI configuration request is adapted for notifying of the existence of the mobile communication unit. Additionally or alternatively, the GUI configuration request is adapted to request instructions for modifying the GUI of the mobile communication unit. For example, the GUI configuration request can comprise device information of the mobile communication unit, such as features and/or functionality supported by the mobile communication unit or other like device information, as discussed previously.

According to an exemplary embodiment, the mobile communication unit is in communication with a suitable GUI server. A communication link from the mobile communication to the GUI server can be established when the GU configuration request is automatically generated. The GUI server can generate a GUI configuration response for configuring the GUI of the mobile communication unit. Accordingly, in step 610, a GUI configuration response to the GUI configuration request can be received by the mobile communication unit. The GUI configuration response can include any suitable type and kind of information that is capable of specifying and defining the layout and organization of the GUI of the mobile communication unit. In particular, the GUI configuration information can comprise instructions for arranging one or more graphical elements within the GUI of the mobile communication unit. For example, the GUI configuration response can comprise one or more GUI elements, and GUI configuration information for configuring the GUI with the one or more GUI elements. In step 615, the GUI of the mobile communication unit is configured in accordance with the GUI configuration response.

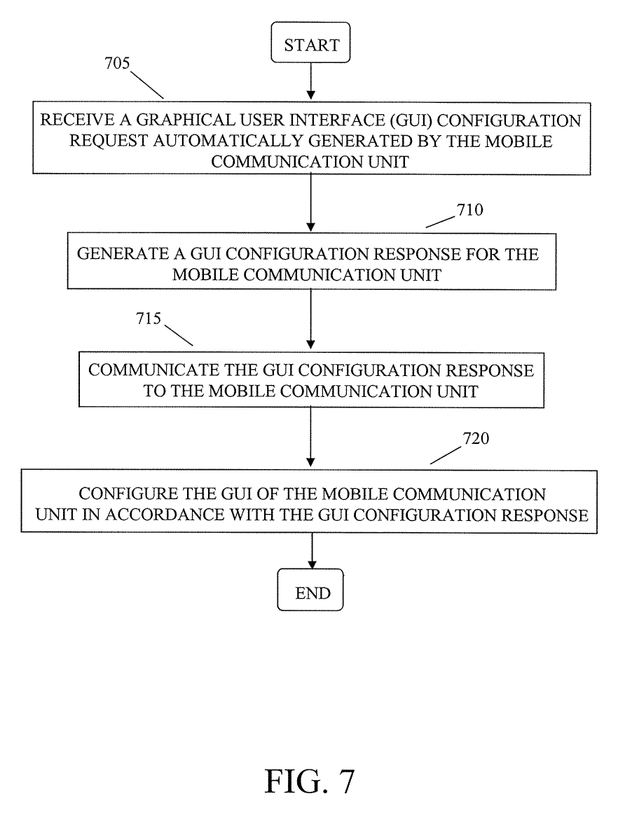

FIG. 7 is a flowchart illustrating steps for adaptively and dynamically configuring a graphical user interface of a mobile communication unit, in accordance with an exemplary embodiment of the present invention. In step 705, a GUI configuration request automatically generated by the mobile communication unit is received. The GUI configuration request can comprise a notification of the existence of the mobile communication unit. Additionally or alternatively, the GUI configuration request can be adapted to request instructions for modifying the GUI of the mobile communication unit. The GUI configuration request can include other suitable information, such as, for example, device information that specifies the mobile communication unit (e.g., features and/or functionality supported by the mobile communication unit or other like device information).

In step 710, a GUI configuration response can be generated for the mobile communication unit. For example, the GUI configuration response can include at least one graphical element and GUI configuration information for configuring a GUI of the mobile communication unit with the at least one graphical element. The GUI configuration information can comprise, for example, instructions for arranging the at least one GUI element within the GUI of the mobile communication unit. In step 715, the GUI configuration response is communicated to the mobile communication unit. In step 720, the GUI of the mobile communication unit is configured in accordance with the GUI configuration response.

Each, all or any combination of the steps of a computer program as illustrated in FIGS. 5-7 for configuring a graphical user interface can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. As used herein, a “computer-readable medium” can be any means that can contain, store, communicate, propagate, or transport the program for use by or in connection with the instruction execution system, apparatus, or device. The computer readable medium can be, for example but not limited to, an electronic, magnetic, optical, electromagnetic, infrared, or semiconductor system, apparatus, device, or propagation medium. More specific examples (a non-exhaustive list) of the computer-readable medium can include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CDROM).

Exemplary embodiments of the present invention can be used in conjunction with any device, system or process for mobile communication in which is it desirable for a mobile network operator, mobile handset manufacturer, or other like entity to control the “look and feel” of the graphical user interface of the mobile communication device without the need for user intervention. For example, exemplary embodiments can be used wireless systems or processes for communicating information, including, but not limited to, telecommunication systems that use WiFi, WiMAX, or other suitable wireless technologies (e.g., mobile non-GSM and non-CMDA technologies).

It will be appreciated by those of ordinary skill in the art that the present invention can be embodied in various specific forms without departing from the spirit or essential characteristics thereof. The presently disclosed embodiments are considered in all respects to be illustrative and not restrictive. The scope of the invention is indicated by the appended claims, rather than the foregoing description, and all changes that come within the meaning and range of equivalence thereof are intended to be embraced.

All United States patents and patent applications, foreign patents and patent applications, and publications discussed above are hereby incorporated by reference herein in their entireties to the same extent as if each individual patent, patent application, or publication was specifically and individually indicated to be incorporated by reference in its entirety.

What is claimed is:

1. A system for automatically configuring a graphical user interface of a mobile communication device, comprising:
a mobile client application module adapted to execute on the mobile communication device, and
wherein the mobile client application module comprises:
a graphical user interface (GUI) module,
wherein the GUI module is adapted to display a GUI on the mobile communication device; and
a GUI request module in communication with the GUI module,
wherein the GUI request module is adapted to automatically generate a GUI configuration request; and
a GUI request processing module in communication with the mobile client application module,
wherein the GUI request processing module is adapted to generate a GUI configuration response for configuring the GUI of the mobile communication device.

2. The system of claim 1, wherein the GUI configuration request is adapted to request instructions from the GUI request processing module for modifying the GUI of the mobile communication device.

3. The system of claim 1, comprising:
a GUI provider server,
wherein the GUI provider server comprises the GUI request processing module.

4. The system of claim 3, wherein the GUI provider server comprises:
a server communication module in communication with the GUI request processing module,
wherein the server communication module is adapted to communicate the GUI configuration response to the mobile communication device.

5. The system of claim 3, wherein the GUI provider server comprises:
a mobile communication information storage module in communication with the GUI request processing module,
wherein the mobile communication information storage module is configured to store attribute information associated with each mobile communication device.

6. The system of claim 1, wherein the GUI configuration response comprises:
a set of GUI elements; and
GUI configuration information for configuring the GUI of the mobile communication device with the set of GUI elements.

7. The system of claim 6, wherein the GUI configuration information comprises instructions for arranging the set of GUI elements within the GUI of the mobile communication device.

8. An apparatus for adaptively and dynamically configuring a graphical user interface, comprising:
a mobile communication unit,
wherein the mobile communication unit comprises:
a graphical user interface (GUI),
wherein the GUI is adapted to display information to a user; and
a GUI configuration module in communication with the GUI,
wherein the GUI configuration module is adapted to automatically generate a GUI configuration request,
wherein the GUI configuration module is adapted to receive a GUI configuration response to the GUI configuration request, and
wherein the GUI configuration response comprises:
one or more GUI elements; and
GUI configuration information for configuring the GUI with the one or more GUI elements.

9. The apparatus of claim 8, wherein the GUI configuration module is adapted to automatically generate the GUI configuration request upon startup of the mobile communication unit.

10. The apparatus of claim 8, wherein the GUI configuration request comprises device information of the mobile communication unit.

11. The apparatus of claim 8, wherein the mobile communication unit is in communication with a GUI server.

12. The apparatus of claim 8, wherein the GUI configuration information comprises instructions for arranging the one or more GUI elements within the GUI of the mobile communication unit.

13. The apparatus of claim 8, wherein the GUI configuration module is adapted to configure the GUI of the mobile communication unit in accordance with the GUI configuration response.

14. An apparatus for adaptively and dynamically configuring a graphical user interface of a mobile communication unit, comprising:
a graphical user interface (GUI) server,
wherein the GUI server is in communication with the mobile communication unit, and
wherein the GUI server comprises:
a GUI response module,
wherein the GUI response module is adapted to receive a GUI configuration request automatically generated by the mobile communication unit,
wherein the GUI response module is adapted to generate a GUI configuration response for the mobile communication unit, and
wherein the GUI configuration response comprises at least one graphical element and GUI configuration information for configuring a GUI of the mobile communication unit with the at least one graphical element.

15. The apparatus of claim 14, wherein the GUI configuration request is adapted to request instructions from the GUI response module for modifying the GUI of the mobile communication unit.

16. The apparatus of claim 14, wherein the GUI configuration request comprises device information of the mobile communication unit.

17. The apparatus of claim 14, wherein the GUI server comprises:
a transceiver module in communication with the GUI response module,
wherein the transceiver module is adapted to communicate the GUI configuration response to the mobile communication unit.

18. The apparatus of claim 14, wherein the GUI server comprises:
a mobile communication information storage module,
wherein the mobile communication information storage module is configured to store attribute information associated with each mobile communication unit.

19. A method of adaptively and dynamically configuring a graphical user interface, comprising the steps of:
a.) transmitting a graphical user interface (GUI) configuration request automatically generated by a mobile communication unit,
wherein the mobile communication unit includes a GUI for displaying information to a user;
b.) receiving a GUI configuration response to the GUI configuration request at the mobile communication unit,
wherein the GUI configuration response includes one or more GUI elements, and GUI configuration information for configuring the GUI with the one or more GUI elements.

20. The method of claim 19, wherein the GUI configuration information comprises instructions for arranging the one or more GUI elements within the GUI of the mobile communication unit.

21. The method of claim 19, comprising the step of:
c.) configuring the GUI of the mobile communication unit in accordance with the GUI configuration response.

22. A method of adaptively and dynamically configuring a graphical user interface of a mobile communication unit, comprising the steps of:
a.) receiving a GUI configuration request automatically generated by the mobile communication unit;
b.) generating a GUI configuration response for the mobile communication unit,
wherein the GUI configuration response includes at least one graphical element and GUI configuration information for configuring a GUI of the mobile communication unit with the at least one graphical element; and
c.) communicating the GUI configuration response to the mobile communication unit.

23. The method of claim 22, wherein the GUI configuration request is adapted to request instructions for modifying the GUI of the mobile communication unit.

24. The method of claim 22, wherein the GUI configuration request comprises device information of the mobile communication unit.

25. The method of claim 22, wherein the GUI configuration information comprises instructions for arranging the at least one GUI element within the GUI of the mobile communication unit.

26. A computer-readable medium containing a graphical user interface (GUI) configuration message structure for adaptively and dynamically configuring a GUI of a mobile communication device, the GUI configuration message structure comprising:
one or more GUI elements; and
GUI configuration information for configuring the GUI of the mobile communication device with the one or more GUI elements,
wherein the GUI configuration message structure is generated in response to a GUI configuration request message automatically generated by the mobile communication device.
